(19) United States
(12) Patent Application Publication
(10) Pub. No.: US 2010/0141956 A1
(43) Pub. Date: Jun. 10, 2010

(54) DUAL BEAM HETERODYNE FOURIER DOMAIN OPTICAL COHERENCE TOMOGRAPHY

(76) Inventors: Rainer Leitgeb, Ecublens (CH); Martin Villiger, Ecublens (CH); Roland Michaey, Chavnnes-renens (CH); Theo Lasser, Denges (CH); Adrian Bachmann, Renens (CH)

Correspondence Address: NIXON & VANDERHYE, PC, 901 NORTH GLEBE ROAD, 11TH FLOOR, ARLINGTON, VA, 22203, US

(21) Appl. No.: 12/523,398

(22) PCT Filed: Jan. 21, 2008
(86) PCT No.: PCT/IB2008/050205

§ 371 Date: Jan. 5, 2010

(30) Foreign Application Priority Data
Jan. 20, 2007 (IB) PCT/IB2007/050193

(51) Int. Cl. G01B 9/02

(52) U.S. Cl. 356/484

(57) ABSTRACT

The present invention relates to an apparatus and a method combining achromatic complex FDOCT signal reconstruction with a common path and dual beam configuration. The complex signal reconstruction allows resolving the complex ambiguity of the Fourier transform and to enhance the achievable depth range by a factor of two. The dual beam configuration shares the property of high phase stability with common path FDOCT. This is of importance for a proper complex signal reconstruction and is in particular useful in combination with handheld probes such as in endoscopy and catheter applications. The advantages of the present invention are in particular the flexibility to choose arbitrarily positioned interfaces in the sample arm as reference together with the possibility to compensate for dispersion.

### FIELD OF INVENTION

The present invention relates to Fourier Domain Optical Coherence Tomography, commonly named FDOCT.

### STATE OF THE ART

FDOCT has nowadays reached large acceptance in the biomedical imaging community due to the sensitivity advantage together with the possibility of high resolution imaging at high acquisition speed [1-7]. Recent realizations based on swept source technology achieve unprecedented scan speeds of several 100kHz with high phase accuracy [8-10]. Still, drawbacks of FDOCT are the depth dependent sensitivity as well as the complex ambiguity of the FDOCT signal leading to disturbing mirror structures as well as maximum depth ranging restrictions. A potential candidate to remove those artifacts is heterodyne FDOCT, both for the spectrometer-based [11] as well as for the swept source modality [12-14].

Nevertheless, in particular spectrometer-based FDOCT needs high phase stability between successive spectra. Any phase noise due to sample motion or mechanical beam scanning will cause signal degradation as well as insufficient suppression of mirror terms. This will be especially critical for in-vivo measurements. Another source of phase instabilities are fiber-based setups in case of employing handheld scanners where moving the sample arm fiber introduces unwanted phase changes.

A solution to above problems is a common path configuration where sample and reference beam travel through the same fiber to the sample or most generally to an applicator. For the true common path concept a prominent sample arm reflection serves as reference signal in which case reference and sample field exhibit maximum relative phase stability. Particularly phase contrast schemes profit of the enhanced phase stability enabling highly sensitive optical path length variations [15-19]. The other common path variant is to have a separate reference arm by placing the interferometer into the hand piece or applicator, as was demonstrated by Tumlinson et al. with an endoscope configuration [20].

The concept of a common path with a prominent sample reflection as a reference captivates by its simplicity due to the fact that it does not need an extra interferometer. As already mentioned a prominent reflection (R₁) situated close to the sample structure (R₂) plays the role of the reference arm (see FIG. 1), resulting in a relative delay of 2Δz. Such a configuration presents extremely high phase stability; values down to 18 pm for spectrometer-based [21] and 39 pm for swept-source based [18] OCT systems have already been reported. However, not much flexibility is offered to the user since the reference reflector must always be close to the sample structure. Also beam scanning might be problematic if the probe scans not telecentrically in order to guarantee a stable reference reflection intensity. Usually a glass window may serve as a reference interface. Nevertheless, the thickness of the glass plate will reduce the achievable depth range apart from the possibility of ghost terms due to the reflections on both glass interfaces. Using the interface that is closer to the sample as reference might improve the situation but the drawback will still be a changing reference reflectivity and thus a changing OCT signal if the sample touches the interface. The only sensible application to profit from the extraordinary phase stability of such configuration seems to be coherent phase microscopy [15-17, 19].

### GENERAL DESCRIPTION OF THE INVENTION

One objective of the present invention is to introduce a dual beam FDOCT variant that profits from the high phase stability of a common path configuration if used in conjunction with handheld applicators, without sacrificing measurement depth range, and keeping the flexibility for beam scanning as well as the possibility of dispersion balancing.

The above objection is obtained with the present invention which relates to an apparatus and a method of use as defined in the claims.

The invention may be advantageously used to perform in-vivo measurements employing spectrometer-based heterodyne FDOCT.

### DETAILED DESCRIPTION OF THE INVENTION

### Short Description of the Figures

FIG. 1. Concept of a common path configuration. A prominent reflection (R₁) close to the sample structure (R₂) is used as reference signal. Δz is the optical path difference between the sample interfaces R₁ and R₂.

FIG. 2. (a) Dual beam principle. The output of an interferometer with a relative delay of 2Δz_{IILS} between the two light beam intensities I_{R} and I_{S} (interferometric light source) is pre-compensating for the relative distance between R₁ (reference surface) and R₂ (sample). The configuration presents a small relative distance Δz between reference surface (R₁) and sample (R₂) and up to four cross correlation terms might occur. The blue beam can be considered as the reference beam. (b) Dual beam configuration presenting a large relative distance Δz as compared to the depth range of the spectrometer (or swept source respectively) and only one cross correlation term occurs.

FIG. 3. Scheme illustrating the filling of a camera pixel in case of dual beam and standard FDOCT respectively.

FIG. 4. Dual beam heterodyne FDOCT. Inlet A depicts synchronization of the line detector ((b) trigger and (c) exposure time) with (a) the beating signal. Inlet B shows the reference arm added (same fiber length as in sample arm) and used for phase stability comparison (§4) between the dual beam and the standard configuration. See text for details.

FIG. 5. (2.2 MB) Time sequence of 500 depth scans per tomogram at same position, using the setup depicted in FIG. 4. The movie is shown at 5 fps (7× reduced speed with respect to original acquisition rate). The dual beam signal (red) remains stable even if the fiber is perturbed whereas the signal peak corresponding to the standard setup (blue) is heavily perturbed. The dashed line indicates the standard deviation σ_{std} of the phase fluctuations over one tomogram. The shown tomogram depth is approximately 400 μm (in air), SNR≈26.5 dB.

FIG. 6. Tomogram of human fingertip with sweat gland, slice from 3D stack of FIG. 7(a), indicated by red frame. (a) Direct FFT on measured data, (b) with background correction employing averaging before FFT, (c) differential complex reconstruction and (d) standard complex reconstruction with background correction. Frame size: 2.5 mm lateral×1.92 mm depth, in air.

FIG. 7. (a) Tomogram of human finger tip (structure size: 2.5 mm×2. mm×˜1.1 mm, in air) with the lower wavy grey line delimiting the dermis-epidermis border and the grey frame indicating the position of the 2D tomogram shown in FIG. 6. (b) Thickness map of epidermis in (a) (top view, size: 2.5 mm×2 mm, corrected for nₜᵢₛₛᵤₑ=1.34).

Method

Dual Beam

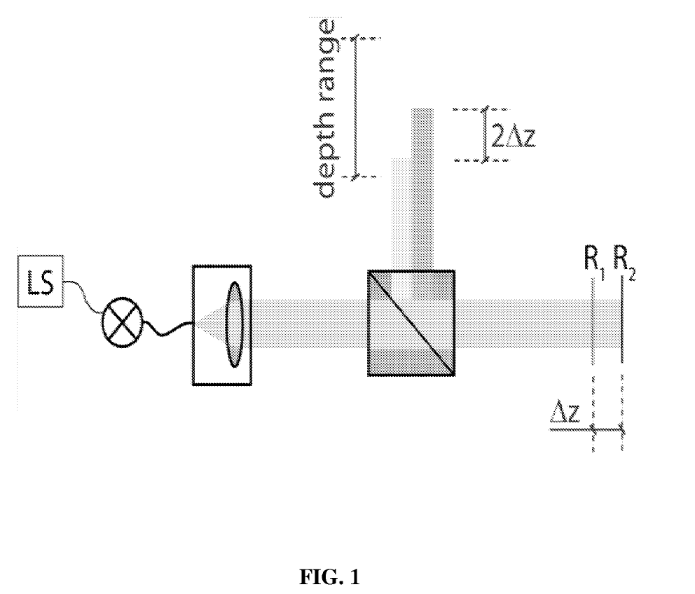

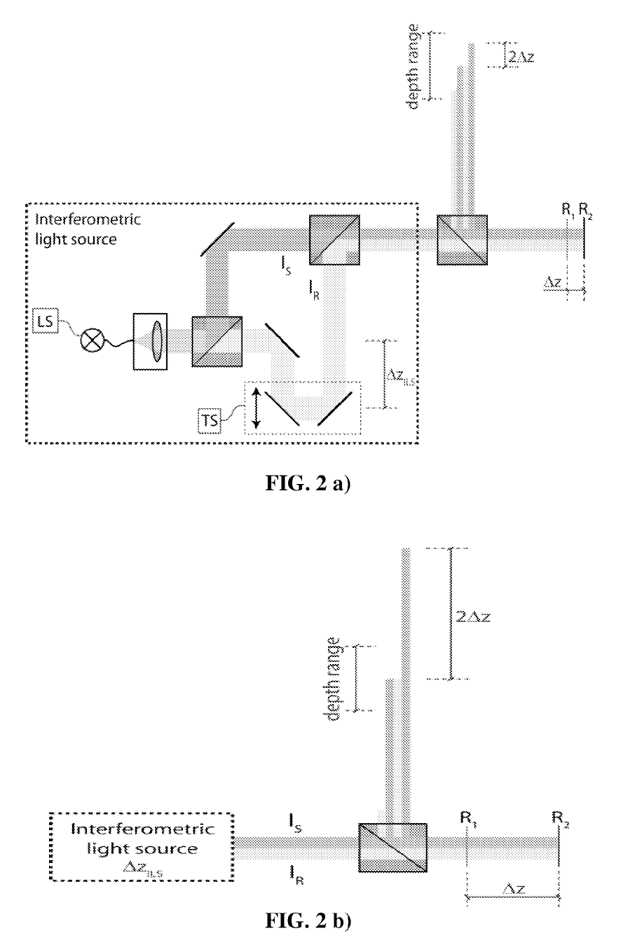

A dual beam configuration is an extension of a common path setup presented in the previous paragraph. Instead of a single light beam travelling the common path to the reference (R₁) and the sample (R₂) as illustrated in FIG. 1, two beams delayed by an optical path length 2Δz_{ILS} enter the common path and travel together to the reference and sample (see FIG. 2(a)). In this case, again, both reference and sample light share the same path and exhibit therefore high relative phase stability. This concept has been adapted for time domain OCT in particular for precise eye length measurements in order to remove artefacts due to axial probe and motion [22, 23].

In the simplest case, a single reflecting sample surface and one reference reflector cause four light fields with relative respective delays. Depending on the optical distance Δz between reference R₁ and sample R₂ and the introduced delay Δz_{ILS} within the interferometric light source (ILS) (see FIG. 2(a)), a perfect match between the two fields can be achieved, as illustrated in FIG. 2(a) for Δz_{ILS}=Δz₀. As a matter of fact, all light fields present within the unambiguous depth range of the Fourier domain system (spectrometer-based or swept source) are coherently summing up and contribute to the detected interference signal. This clearly has a strong adverse effect on the achievable system dynamic range. However, the potential of the dual beam configuration lies in the possibility to choose an arbitrarily distant interface in the common path as reference by matching the respective delay Δz_{ILS} of the interferometric light source as illustrated in FIG. 2(b).

In the most general way, the intensity of the total optical field impinging on the camera array in case of a single reflecting sample surface can be written as:

$$\begin{matrix}{I}_{CCD} = ( {E}_{R}^{( r )} + {E}_{R}^{( s )} + {E}_{S}^{( r )} + {E}_{S}^{( s )} ) ( {E}_{R}^{{( r )}^{*}} + {E}_{R}^{{( s )}^{*}} + {E}_{S}^{{( r )}^{*}} + {E}_{S}^{{( s )}^{*}} ) \\ = {E}_{R}^{( r )} {E}_{R}^{{( r )}^{*}} + {E}_{R}^{( r )} {E}_{R}^{{( s )}^{*}} + {E}_{R}^{( r )} {E}_{S}^{{( r )}^{*}} + {E}_{R}^{( r )} {E}_{S}^{{( s )}^{*}} ++ \\ {E}_{R}^{( s )} {E}_{R}^{{( r )}^{*}} + {E}_{R}^{( s )} {E}_{R}^{{( s )}^{*}} + {E}_{R}^{( s )} {E}_{S}^{{( r )}^{*}} + {E}_{R}^{( s )} {E}_{S}^{{( s )}^{*}} ++ \\ {E}_{S}^{( r )} {E}_{R}^{{( r )}^{*}} + {E}_{S}^{( r )} {E}_{R}^{{( s )}^{*}} + {E}_{S}^{( r )} {E}_{S}^{{( r )}^{*}} + {E}_{S}^{( r )} {E}_{S}^{{( s )}^{*}} ++ \\ {E}_{S}^{( s )} {E}_{R}^{{( r )}^{*}} + {E}_{S}^{( s )} {E}_{R}^{{( s )}^{*}} + {E}_{S}^{( s )} {E}_{S}^{{( r )}^{*}} + {E}_{S}^{( s )} {E}_{S}^{{( s )}^{*}}\end{matrix} \qquad ( 1 )$$

with

$${E}_{R , S}^{( r , s )} = \sqrt{{I}_{R , S}^{( r , s )} ( k )} {e}^{j ( {kz}_{R , S}^{( r , s )} )}$$

being the detected reference and sample light fields respectively, with I_{R,S}^{(r,s)}=I_{R,S}ρ_{r,s}² being the light intensity contributions at the detector and ρᵣ being the amplitude reflectivity of R₁ in FIG. 2 and ρₛ the sample amplitude reflectivity (R₂ in FIG. 2), both accounting also for coupling losses, additional losses on optical elements and the diffraction grating efficiency. The upper indexes (r) or (s) indicate whether the contribution is coming from the reference beam I_{R} or the sample beam I_{S} of the ILS respectively. k stands for the wave number and z_{R,S} are the integral optical path lengths travelled by the respective light fields. The shading in Eq. (1) visualizes the different contributions to the signal generation: the green shaded elements correspond to the four DC terms; the yellow elements are the complex conjugates to the ones on the bottom left side of the DC terms; the red shaded elements are zero if the reference surface is placed far away from the sample surface (see FIG. 2(b)) such that the coherence function becomes zero and no interference will occur anymore; for the same reason the blue shaded elements would vanish as well due to the matched delay Δz_{ILS}≈Δz between the two fields E_{R} and E_{S}.

Hence one is finally left with the DC components as well as the actual sample-reference cross-correlation term in the lower left corner of Eq. (1) together with its complex conjugate. The delay Δz_{ILS} can be used to adjust the position of the sample structure within the unambiguous depth range.

In case of the reference interface being close to the actual sample structure one encounters all terms given in Eq. (1). One could introduce a dispersion unbalance between the reference (R₁) and the sample (R₂) field, and place double the dispersion into the reference arm of the ILS. Different undesired cross correlation terms would then be attenuated since they experienced double or quadruple dispersion whereas the actual structure terms were dispersion corrected.

Nevertheless one still suffers from the complex conjugate mirror terms that lead to a reduced maximum system depth range and might obstruct the structure reconstruction.

Heterodyne Dual Beam

The concept of heterodyne spectrometer-based FDOCT was already discussed by Bachmann et al. [11]: slight detuning of two acousto-optic frequency shifters in the reference and sample arm of the interferometer causes an achromatic beating signal of frequency Ω=|Ω_{R}−Ω_{S}| detected by the sensor. By quadrature detecting this timely varying signal the full complex signal can be reconstructed and the unambiguous depth range is doubled. For this purpose the detector is locked to four times the beating frequency, resulting in π/2 phase shifted copies of the time dependent interference signal components. The frequency-shifted light fields can be written as:

$${E}_{R , S}^{{( r , s )}^{′}} = \sqrt{{I}_{R , S}^{( r , s )} ( k )} {e}^{j ( {kz}_{R , S}^{( r , s )} - ( {ω}_{0} + {ω}_{R , S} ) t )} , \qquad ( 2 )$$

with Ω₀ being the light frequency and Ω_{R,S} the frequency shift induced by the acousto-optic frequency shifters. The resulting signal detected by the line scan camera therefore becomes, for the case where reference and sample are well separated (see FIG. 2(b)):

I_{CCD}(k,t)=I_{R}^{(r)}(k)+I_{R}^{(s)}(k)+I_{S}^{(r)}(k)+I_{S}^{(s)}(k)+2{square root over (I_{R}^{(r)}(k)I_{S}^{(s)(}k))} cos(Ωt−Ψ), (3)

with Ψ containing all time-independent phase terms. Beside the additional DC terms I_{R}^{(s)}(k) and I_{S}^{(r)}(k), this signal is equal to a standard heterodyne FDOCT configuration and has the same properties with respect to the suppression of mirror terms. Dual beam heterodyne FDOCT therefore allows for displacing the actual sample structure along the full doubled depth range by adjusting the distance Δz_{ILS}.

The DC and auto-correlation terms due to internal interferences between sample structure fields can be further eliminated using a differential complex signal reconstruction according to [11]:

$$\begin{matrix}{\tilde{I}}_{2 \times 2} ( k , {t}_{0} ) = \tilde{I} ( k , {t}_{0} ) - \tilde{I} ( k , {t}_{0} + \frac{π}{Ω} ) \\ = 2 ( {I}_{A C} ( k , {t}_{0} ) - j {I}_{A C} ( k , {t}_{0} + \frac{π / 2}{Ω} ) ) ,\end{matrix} \qquad ( 4 )$$

with

$$\tilde{I} ( k , {t}_{0} ) = I ( k , {t}_{0} ) - j I ( k , {t}_{0} + \frac{π / 2}{Ω} )$$

being the complex reconstructed interference signal of two adjacent spectra recorded at an arbitrary time instance t₀.

Sensitivity and Dynamic Range

Sensitivity and dynamic range (DR) are important issues in spectrometer-based FDOCT. In practice, the DR depends on the reference light power being set close to the saturation level of the detector in order to achieve maximum sensitivity. It is evident that the dual beam configuration will present smaller sensitivity than standard FDOCT due to the presence of a second strong DC signal I_{S}^{(r)}(k) not serving as reference signal for coherent amplification but reducing CCD dynamics. We would therefore like to comment more in detail on DR and sensitivity of the dual beam configuration as compared to the standard configuration in spectrometer-based FDOCT.

In §2.1 we defined the beam intensities in the ILS (see FIG. 2(a)) to be I_{R} and I_{S} respectively. The corresponding amount of generated photoelectrons [2, 5] is then

$${N}_{R , S} ( k ) = {I}_{R , S}^{( r , s )} ( k ) β ( k ) {A}_{pixel} with β ( k ) = \frac{τ η ( k )}{ℏ kc}$$

as the photon conversion factor with the reduced Planck constant h̅, the vacuum light speed c, τ the integration time of the camera, η(k) the detector quantum efficiency, h̅kc the photon energy in vacuum, and Aₚᵢₓₑₗ the size of a detector pixel. We further express the total spectrally integrated number of photoelectrons as function of the spectral peak value as Nₜₒₜ=αN(k₀), with k₀ being the center wave number where the detected spectrum is assumed to have its maximum. For a Gaussian spectrum with the spectral FWHM being imaged onto Nlm pixels, i.e. Δk_{FWHM}⁽ⁿ⁾=N/m, we have α_{Gauss}=Δk_{FWIM}⁽ⁿ⁾\sqrt{π/(4ln2)}, where N is the total number of detector pixels, and m defines the ratio of N to the FWHM. In case of a rectangular spectrum α_{rect}=N. According to Eq. (3) the signal term can be written as:

N_{signal}(k)=N_{AC}(k)=2\sqrt{N_{ref}(k)Nₛₐₘₚₗₑ(k)} cos(Ωt−Ψ). (5)

with N_{ref}(k)≡β(k)I_{R}(k)ρᵣ²Aₚᵢₓₑₗ and Nₛₐₘₚₗₑ(k)≡β(k)I_{S}(k)ρₛ²Aₚᵢₓₑₗ. An additional assumption we make is that the presence of a reference surface in the sample arm does not influence the ratio of sample to reference reflectivity ρₛ/ρᵣ, significantly, which means that the transmittance of the reference surface is high. With the approximation ρᵣ²>>ρₛ², we consider only those fields for the DC term that are reflected at the reference interface R₁:

$${N}_{D C} \approx {N}_{ref} ( k ) + {N}_{sample} ( k ) \frac{{ρ}_{r}^{2}}{{ρ}_{s}^{2}} ≡ γ {N}_{sat} , \qquad ( 6 )$$

where we define a load factor y as the ratio between DC level and the pixel saturation level Nₛₐₜ. This definition will be useful for our dynamic range discussion since the maximum sample signal will clearly depend on the remaining pixel capacity. We would further like to find the optimum ratio ξ between the ILS intensities I_{R} and I_{S}. With the definition I_{S}≡ξI_{R} and Eq. (6), the number of photoelectrons corresponding to the sample signal becomes:

$${N}_{sample} = ξ \frac{{ρ}_{s}^{2}}{{ρ}_{r}^{2}} {N}_{ref} = \frac{ξ}{1 + ξ} \frac{{ρ}_{s}^{2}}{{ρ}_{r}^{2}} γ {N}_{sat} . \qquad ( 7 )$$

The signal-to-noise ratio (SNR) can be defined as SNR= [symbol] S_{OCT}² [symbol] /\ddot{σ}², with [symbol] • [symbol] being the time average, S_{OCT}=FT{N_{D}(k)}|_{z}_{₀} being the signal peak at the position z₀=Δz−Δz_{ILS} after Fourier Transform (FT) and \ddot{σ} the noise variance after FT. Following [2] the squared OCT signal reads [symbol] S_{OCT}² [symbol] =(αN_{AC}(k₀)/(2N))². The noise variances before and after FT are related via \ddot{σ}²=σ²/N. For shot-noise limited detection it can be expressed by the pixel-averaged total DC signal with Eq. (6) as \ddot{σ}²≈(1/N)(αγNₛₐₜ/N). Together with Eq. (7), the SNR in this case becomes:

$$SNR = α γ {N}_{sat} \frac{{ρ}_{s}^{2}}{{ρ}_{r}^{2}} \frac{ξ}{{( 1 + ξ )}^{2}} . \qquad ( 8 )$$

We observe firstly that the SNR increases linearly with the load factor γ. Secondly, the SNR expression reaches a maximum for ξ=1, or I_{R}=I_{S}. In words, the two interferometer arms of the ILS should have the same intensity in order to achieve a maximum SNR in dual beam interferometry. This is an important conclusion which will facilitate the following comparison of dual beam to standard FDOCT.

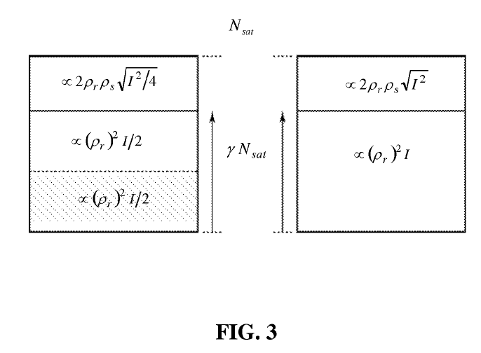

FIG. 3 shows in an intuitive way the signal contributions on camera pixel level at spectral position k₀ with equal load factor γ (detected signal when sample light is blocked) where we assume the cosine in Eq. (3) to be 1. Since maximum SNR is achieved for both arms of the ILS at equal intensity (ξ=1) we can write I_{R}=I_{S}=I/2. The dotted region indicates the light intensity reflected by the reference surface R₁ which does not contribute to coherent amplification—but still contributes to shot noise and burdens the sample with additional light power. Hence, the effective reference signal for dual beam is only half that of the standard configuration with equal noise floor which results in a decreased SNR. According to FIG. 3 the SNR can be expressed as:

SNR_{dual} ∝ ρₛ²I, and SNR_{std} ∝4ρₛ²I, thus SNR_{dual}=SNR_{std}/4. (9)

However, the maximum SNR is the same for both configurations as it is limited by the saturation value of the camera pixel. This implies the relation for the maximum sample reflectivity assuming equal reference signal:

$${( {ρ}_{s , dual}^{( ma x )} )}^{2} = 4 {( {ρ}_{s , std}^{( ma x )} )}^{2} . \qquad ( 10 )$$

The sensitivity Σ on the other hand is defined as the inverse of the smallest detectable sample reflectivity (ρₛ^{(min)})² i.e. Σ=1/(ρₛ^{(min)})² for SNR≡1. From Eq. (9) and with the same load factor γ for both configurations, we can write:

$${Σ}_{dual} = \frac{1}{4} {Σ}_{std} , \qquad ( 11 )$$

which is equivalent to a −6 dB disadvantage in sensitivity for dual beam as compared to standard FDOCT. Together with Eq. (10) we can deduce the following relation:

$${( {ρ}_{s , dual}^{( ma x )} )}^{2} / {( {ρ}_{s , std}^{( ma x )} )}^{2} = {( {ρ}_{s , dual}^{( m i n )} )}^{2} / {( {ρ}_{s , std}^{( m i n )} )}^{2} , \qquad ( 12 )$$

i.e. the ratio between maximum and minimum sample reflectivity remains the same.

This relation leads us directly to the implications to DR which is defined as the ratio between the maximum to the minimum SNR. For a given reference intensity and load factor γ, the maximum SNR is achieved for the maximum sample reflectivity (ρₛ^{(max)})². Since the minimum SNR depends on the minimum sample reflectivity and considering Eq. (12), the DR will remain the same for dual beam and standard FDOCT:

$${DR}_{dual} = {DR}_{std} ∝ {N}_{sat} \frac{{( 1 - γ )}^{2}}{γ} . \qquad ( 13 )$$

One could be tempted to increase SNR by increasing the load factor γ (cf. Eq. (8)). However, changing γ from e.g. 0.7 to 0.8 increases the SNR by less than +1 dB while decreasing the DR already by −4 dB (cf. Eq. (13)). The situation becomes even worse for larger load factors.

Experimental

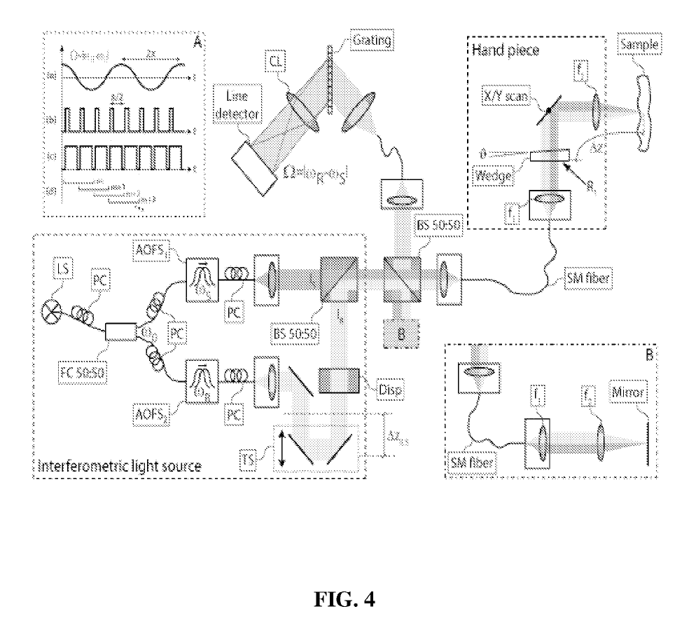

A Mach-Zehnder like interferometer setup as shown in FIG. 4 was built. The spectrometer consists of a collimator with a focal length of 80 mm, a transmission diffraction grating (1200 lines/mm), an objective (CL) with a focal length of 135 mm and a line scan camera (ATMEL AVIIVA M2, 2048 pixel, 12 bit) driven at 17.4 kHz line rate. The light source (LS) is a Ti:Sapphire laser with center wavelength at 800 nm and a bandwidth (FWHM) of 130 nm. The effectively by the spectrometer detected bandwidth (FWHM) is 90 nm due to spectral transmittance losses along the total system, i.e. coupling losses. The maximum depth range (after complex signal reconstruction) is 4 mm and the axial resolution in air is 4 μm. The signal drop-off along the depth range is approximately −7 dB/mm with a sensitivity close to the zero delay of about 95 dB with 2×1.1 mW light power incident on the sample and a load factor γ of 0.8. Using Eq. (8) the theoretical sensitivity is calculated to be Σ_{dual}≈101 dB with ξ=1, α=800, γ=0.8, Nₛₐₜ≈1.2·10⁵ and ρᵣ²≈1.4·10⁻³. The reference arm length can be adjusted by means of a translation stage (TS). Beam splitting and recombination is realized by a fiber coupler (FC) and a 50:50 beam splitter (BS) respectively.

The peculiarity of the proposed system is the light source module comprising an interferometer with two acousto-optic frequency shifters (AOFS) (AA Opto-Electronic SA with optical packaging by Cube Optics AG, Ω_{R}=2π·100 MHz, Ω_{S}=2π·100 MHz+4.35 kHz). Since our acousto-optic elements are based on a birefringent crystal (tellurium dioxide (TeO₂)) light has to enter these devices in a controlled, linear polarization state. In addition, in order to maximize interference contrast, the light field states at the common path input have to be oriented accordingly, employing polarization control paddles (PC) (see FIG. 4). The sample is finally illuminated by two frequency shifted copies of the original light field. The dispersion compensation (Disp) in the reference arm of the ILS pre-compensates for the additional dispersion induced by the wedge plate and the lens f₂ of the hand piece.

The hand piece consists of a scanning unit based on a single mirror tip/tilt scanner (X/Y scan) [24]. It is placed in the back focal plane of lens f₂, allowing for two-dimensional transverse scanning of the sample. The glass wedge with a deviation angle of 2° (θ≈3.1°) is used in order to create a single well defined reference reflex at the front surface. Such a configuration can be seen as auto-collimation and the reference signal intensity is adjusted by slightly tilting the glass wedge. The theoretical beam width on the sample is 26.5 μm (1/e²-intensity) with a Rayleigh range of 1.3 mm and is defined by the ratio of the focal lengths (f₁=15 mm, f₂=75 mm) used in the handheld probe and the mode field diameter of the one meter single mode (SM) fiber. With a transverse scanning speed across the sample of 40 mm/s the resulting transverse over-sampling is approximately 12×.

In order to properly reconstruct the complex signal as described in §2.2, special attention has to be paid to the synchronization of the camera with the resulting beating frequency (cf. inlet A of FIG. 4). The complex differential reconstruction needs two pairs of complex reconstructed spectra Ĩ(k) (thus in total four by 90° retarded acquisitions) which is realized by externally triggering the camera frame grabber (see (b) in inlet A of FIG. 4). Frequency shifters and trigger signal generators are linked and synchronized via a common 10 MHz time base. The exposure time τ (see (c) in inlet A of FIG. 4) is 45 μs. The complex spectra Ĩ(k) (see §2.2) are finally reconstructed using two successively recorded spectra as indicated by (d) in inlet A of FIG. 4.

With the extension shown in inlet B of FIG. 4 we had the flexibility to compare the phase stability of the following three configurations:
Common path: By blocking the dual beam arm and placing a thin glass plate instead of the mirror in inlet B.
Dual beam: By blocking the external reference arm (inlet B). For phase stability measurement a mirror was used as sample without X/Y scanner.
Standard: Cross-correlation between mirror of inlet B and mirror at sample position of the dual beam arm (top right corner in FIG. 4).

Dual beam and standard FDOCT could be measured simultaneously by adjusting the two respective reference signals R₁ (for dual beam) and mirror of inlet B (for standard) to 0.4 each.

Results and Discussion

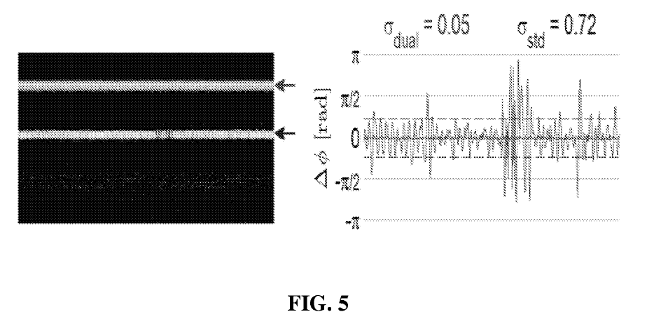

In order to demonstrate the advantage of dual beam versus standard FDOCT in terms of phase stability, the previously described three configurations were used (FIG. 4). For each configuration the SNR of the signal peak was adjusted to approximately 26.5 dB. The phase fluctuations at the signal peak position were measured while the system was unperturbed and perturbed respectively. The perturbation consisted in bending and moving the sample arm fiber guiding during measurement. The resulting standard deviations of the phase fluctuations σ_{Δ,φ} are shown in Table 1. The measured values are close to shot noise limited phase stability defined by the relation σ_{Δ,φ}=(SNR)^{-1/2} [25]. For the perturbed case of the standard FDOCT configuration no clear value could be measured since the phase fluctuations are strongly varying (see FIG. 5).

TABLE 1
Phase fluctuations for three different configurations
with similar local SNR ≈ 26.5 dB.

| | Without | With |
|---|---|---|
| | perturbation | perturbation |
| Common path | σ_{Δφ} ≈ 47.7 mrad | σ_{Δφ} ≈ 48.8 mrad |
| Dual beam | σ_{Δφ} ≈ 48.5 mrad | σ_{Δφ} ≈ 51.2 mrad |
| Standard | σ_{Δφ} ≈ 49.5 mrad | N.A. |

The phase signals were extracted after FFT at the mean signal peak positions. By touching and bending the SM fiber, the signal of the standard setup is heavily perturbed, even resulting in up to 100 μm signal peak shift in depth. This displacement is caused by a change in optical path length due to a stress-induced change in refractive index. Both signal peaks were again adjusted to approximately the same SNR=26.5 dB. The strong fluctuations of the standard signal peak intensity are mainly due to fringe washout and stress-induced polarization state changes in the perturbed fiber, resulting in reduced interference fringe contrast. These measurements proof clearly the advantage of dual beam FDOCT over standard FDOCT for employing fiberized handheld applicators.

In the following we demonstrate the feasibility of the introduced dual beam FDOCT principle to perform in-vivo imaging of human skin on the finger tip of a male subject. For this task we employed a fiberized handheld probe with a single mirror tip/tilt scanner. The reference reflex was realized by placing a wedge glass plate into the collimated beam before the scanner, generating a stable reference light intensity. Attention had to be paid to the positioning of the beam with respect to the scanner pivot since slight misalignment introduces unwanted phase shifts during scanning. The total distance Δz between reference and sample was 200 mm which had to be pre-compensated by adjusting Δz_{ILS} within the ILS. The recorded tomograms consist of 1100 depth scans each, covering a transverse range of 2.5 mm. The measurements had been performed by first adjusting the focal plane to the zero delay using a mirror and then placing the sample structure across this position.

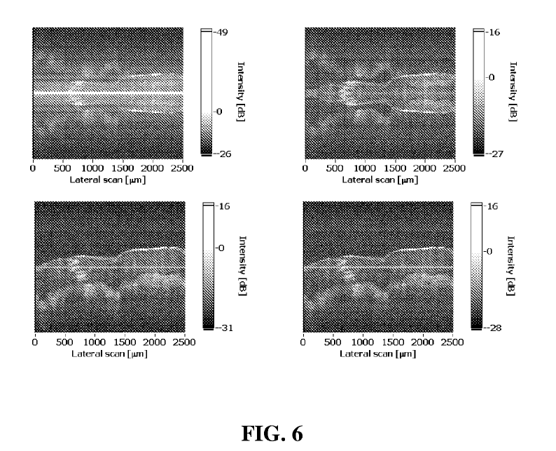

The recorded signal was reconstructed following the differential complex scheme from §2.2 (see FIG. 6(c)). The dynamic range within the tomogram is about 40 dB with a system sensitivity of 95 dB. One observes that the DC term is strongly suppressed as compared to its original amplitude (directly after Fast Fourier Transform (FFT)). If we define the DC suppression ratio as DCₛᵤₚₚᵣₑₛₛ≡DC_{2×2}/DC_{FFT}, with DC_{2×2} being the DC signal value in FIG. 6(c) and DC_{FFT} the one in FIG. 6(a) we have DCₛᵤₚₚᵣₑₛₛ=−47 dB. The fact that the DC term is not fully suppressed is explained by the presence of slight intensity fluctuations throughout the tomogram. These fluctuations were measured to be in the kHz-range with a standard deviation of 0.33%.

In FIG. 6 we compare the differential complex reconstruction technique (Eq. (4)) (FIG. 6(c)) to the standard complex reconstruction based on two adjacent lines Ī(k,t₀) with background correction (FIG. 6(d)). The background for the tomogram is obtained by averaging of all transversally recorded spectra. The brightness of the tomograms was adjusted by first normalising the intensity to that of a common bright structure (sweat gland) and then setting the minimum of the intensity scale bar to the calculated noise floor. The maximum scale bar value is given by the highest intensity in the tomogram. This results in a linear gray scale spanning over a DR of 28.5 dB for standard complex reconstruction and 31 dB for the differential complex reconstruction. As expected, the SNR for the differential complex method is better by approximately +3 dB.as compared to the standard complex reconstruction. It can also be observed that DC suppression works slightly better for the differential complex approach (FIGS. 6(c) and (d))

The tomogram in FIG. 6(a) shows the measured data with standard reconstruction employing straight forward FFT reconstruction. One can clearly see that the structure had been measured across the zero delay due to the presence of mirror structures. FIG. 6(b) finally shows a standard reconstruction as in FIG. 6(a) but with background subtraction in post-processing. Again, a slight DC term remains together with sample structure obstructing mirror terms.

Investigating the mirror term suppression within different 2D tomograms for bright scattering structures, the suppression ratio can be measured to be better than −15 dB. Higher over-sampling would increase the suppression ratio as one remains tighter within the speckle pattern [25].

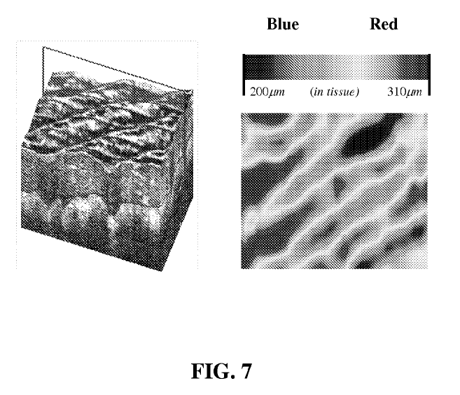

FIG. 7(a) shows a 3D data set of a human finger tip, consisting of 66 2D tomograms and reconstructed using the differential complex scheme. The total recording time was 4.5 s. By performing edge detection on each individual 2D tomogram, the user has access e.g. to a thickness map of the epidermis as illustrated in FIG. 7(b). The grey frame in FIG. 7(a) indicates the position of the 2D tomograms presented in FIG. 6 within the 3D data cube. The rudimentary DC peak at the zero-delay, visible in FIG. 6(c), was removed from FIG. 7(a) by first setting it to zero and afterwards interpolating the intensities in post processing.

The demonstrated principle can easily be adapted for endoscopic OCT as well as for common path ophthalmic imaging. In particular the phase stability can be enhanced by placing the reference to one of the scanning prism interfaces in an endoscope, or by using actually a sample reflection such as at the cornea front surface as reference [26]. In the latter case one could achieve complete axial proband motion suppression which is especially interesting for functional imaging extensions such as Doppler FDOCT [27-30]. Still, using dual beam FDOCT in conjunction with illumination power limited applications such as in ophthalmology one would have a −6 dB sensitivity disadvantage which cannot be compensated by simply increasing illumination power.

Finally, one should mention that the principle of dual-beam heterodyne FDOCT can equally be used for swept source FDOCT. The latter would have the advantage of larger dynamic range, as well as the high A-scan rates of modern swept-sources.

### REFERENCES AND LINKS

1. A. F. Fercher, C. K. Hitzenberger, G. Kamp, and S. Y. Elzaiat, “Measurement of Intraocular Distances by Backscattering Spectral Interferometry,” Optics Commun. 117, 43-48 (1995).
2. R. Leitgeb, C. K. Hitzenberger, and A. F. Fercher, “Performance of Fourier domain vs. time domain optical coherence tomography,” Opt. Express 11, 889-894 (2003).
3. J. F. de Boer, B. Cense, B. H. Park, M. C. Pierce, G. J. Tearney, and B. E. Bouma, “Improved signal-to-noise ratio in spectral-domain compared with time-domain optical coherence tomography,” Opt. Lett. 28, 2067-2069 (2003).
4. M. A. Choma, M. V. Sarunic, C. Yang, and J. Izatt, “Sensitivity advantage of swept source and Fourier domain optical coherence tomography,” Opt. Express 11, 2183-2189 (2003).
5. R. A. Leitgeb, W. Drexler, A. Unterhuber, B. Hermann, T. Bajraszewski, T. Le, A. Stingl, and A. F. Fercher, “Ultrahigh resolution Fourier domain optical coherence tomography,” Opt. Express 12, 2156-2165 (2004).
6. M. Wojtkowski, T. Bajraszewski, I. Gorczynska, P. Targowski, A. Kowalczyk, W. Wasilewski, and C. Radzewicz, “Ophthalmic imaging by spectral optical coherence tomography,” Am. J. Ophthalmol. 138, 412-419 (2004).
7. N. Nassif, B. Cense, B. H. Park, S. H. Yun, T. C. Chen, B. E. Bouma, G. J. Tearney, and J. F. de Boer, “In vivo human retinal imaging by ultrahigh-speed spectral domain optical coherence tomography,” Opt. Lett. 29, 480-482 (2004).
8. S. H. Yun, C. Boudoux, G. J. Tearney, and B. E. Bouma, “High-speed wavelength-swept semiconductor laser with a polygon-scanner-based wavelength filter,” Opt. Lett. 28, 1981-1983 (2003).
9. M. A. Choma, K. Hsu, and J. A. Izatt, “Swept source optical coherence tomography using an all-fiber 1300-nm ring laser source,” J. Biomed. Opt. 10, 44009 (2005).
10. R. Huber, M. Wojtkowski, K. Taira, J. G. Fujimoto, and K. Hsu, “Amplified, frequency swept lasers for frequency domain reflectometry and OCT imaging: design and scaling principles,” Opt. Express 13, 3513-3528 (2005).
11. A. H. Bachmann, R. A. Leitgeb, and T. Lasser, “Heterodyne Fourier domain optical coherence tomography for full range probing with high axial resolution,” Opt. Express 14, 1487-1496 (2006).
12. J. Zhang, J. S. Nelson, and Z. P. Chen, “Removal of a mirror image and enhancement of the signal-to-noise ratio in Fourier-domain optical coherence tomography using an electro-optic phase modulator,” Opt. Lett. 30, 147-149 (2005).
13. S. H. Yun, G. J. Tearney, J. F. de Boer, and B. E. Bouma, “Removing the depth-degeneracy in optical frequency domain imaging with frequency shifting,” Opt. Express 12, 4822-4828 (2004).
14. A. M. Davis, M. A. Choma, and J. A. Izatt, “Heterodyne swept-source optical coherence tomography for complete complex conjugate ambiguity removal,” J. Biomed. Opt. 10 (2005).
15. M. A. Choma, A. K. Ellerbee, C. Yang, T. L. Creazzo, and J. A. Izatt, “Spectral-domain phase microscopy,” Opt. Lett. 30, 1162-1164 (2005).
16. M. V. Sarunic, S. Weinberg, and J. A. Izatt, “Full-field swept-source phase microscopy,” Opt. Lett. 31, 1462-1464 (2006).
17. C. Joo, T. Akkin, B. Cense, B. H. Park, and J. F. De Boer, “Spectral-domain optical coherence phase microscopy for quantitative phase-contrast imaging,” Opt. Lett. 30, 2131-2133 (2005).
18. D. C. Adler, R. Huber, and J. G. Fujimoto, “Phase-sensitive optical coherence tomography at up to 370,000 lines per second using buffered Fourier domain mode-locked lasers,” Opt. Lett. 32, 626-628 (2007).
19. C. Joo, K. H. Kim, and J. F. De Boer, “Spectral-domain optical coherence phase and multiphoton microscopy,” Opt. Lett. 32, 623-625 (2007).
20. A. R. Tumlinson, J. K. Barton, B. Povazay, H. Sattman, A. Unterhuber, R. A. Leitgeb, and W. Drexler, “Endoscope-tip interferometer for ultrahigh resolution frequency domain optical coherence tomography in mouse colon,” Opt. Express 14, 1878-1887 (2006).
21. M. A. Choma, A. K. Ellerbee, S. Yazdanfar, and J. A. Izatt, “Doppler flow imaging of cytoplasmic streaming using spectral domain phase microscopy,” J. Biomed. Opt. 11 (2006).
22. A. F. Fercher, C. K. Hitzenberger, W. Drexler, G. Kamp, H. Sattmann, L. F. Schmetterer, I. Strasser, and C. Unfried, “In-vivo dual-beam optical coherence tomography,” in Proceedings of SPIE—The International Society for Optical Engineering (1994), p. 356.
23. C. K. Hitzenberger, “Optical Measurement of the Axial Eye Length by Laser Doppler Interferometry,” Investigative Ophthalmology & Visual Science 32, 616-624 (1991).
24. M. Hafez, T. C. Sidler, R. P. Salathe, G. L. M. Jansen, and J. C. Compter, “Design, simulations and experimental investigations of a compact single mirror tip/tilt laser scanner,” Mechatronics 10, 741-760 (2000).
25. B. H. Park, M. C. Pierce, B. Cense, S. H. Yun, M. Mujat, G. J. Tearney, B. E. Bouma, and J. F. de Boer, “Real-time fiber-based multi-functional spectral-domain optical coherence tomography at 1.3 μm,” Opt. Express 13, 3931-3944 (2005).
26. A. Baumgartner, C. K. Hitzenberger, H. Sattmann, W. Drexler, and A. F. Fercher, “Signal and resolution enhancements in dual beam optical coherence tomography of the human eye,” J. Biomed. Opt. 3, 45-54 (1998).
27. R. A. Leitgeb, L. Schmetterer, W. Drexler, A. F. Fercher, R. J. Zawadzki, and T. Bajraszewski, “Real-time assessment of retinal blood flow with ultrafast acquisition by color Doppler Fourier domain optical coherence tomography,” Opt. Express 11, 3116-3121 (2003).
28. B. R. White, M. C. Pierce, N. Nassif, B. Cense, B. H. Park, G. J. Tearney, B. E. Bouma, T. C. Chen, and J. F. de Boer, “In vivo dynamic human retinal blood flow imaging using ultra-high-speed spectral domain optical Doppler tomography,” Opt. Express 11, 3490-3497 (2003).
29. L. Wang, Y. Wang, S. Guo, J. Zhang, M. Bachman, G. P. Li, and Z. Chen, “Frequency domain phase-resolved optical Doppler and Doppler variance tomography,” Opt. Commun. 242, 345-350 (2004).
30. A. H. Bachmann, M. Villiger, C. Blatter, T. Lasser, and R. A. Leitgeb, “Resonant Doppler Imaging and optical vivisection of retinal blood flow ” Opt. Express 15, 408-422 (2007).

1. An optical apparatus comprising: a) a broad spectral bandwidth light source, a sample area and an illuminated region adapted to illuminate a sample, b) optical means to split the source field and to produce a reference light field and a sample light field, c) optical means to combine said light fields, d) optical and electronic means to record the spectral interference pattern between said light fields, e) means to introduce a controlled dynamic phase shift between the sample and the reference light field during signal integration, f) means to synchronize the above phase shift with the detection, where the dynamic phase change is adapted to be-tuned to detect, independent of the detection rate and with high sensitivity, the signal of a sample, or of any sample interface moving at arbitrary velocity.

2. The apparatus of claim 1 with means to change the position of said illumination region and means for introducing a general different dynamic phase shift at each position.

3. The apparatus of claim 1 comprising means for detecting movement of said sample, e.g. a biological sample, or for detecting movement of a part of it.

4. The apparatus of claim 1 comprising means for optical segmentation of moving sample sub-structures.

5. The apparatus of claim 1 comprising means for detecting optical path length changes within said sample due to refractive index changes.

6. The apparatus of anyone of claim 1 comprising means for determining the quantitative velocity of any moving interface of said sample.

7. Use of the apparatus as defined in claim 1 including the use of flows signals as contrast parameters in multi-dimensional biological sample imaging.

8. Use of the apparatus as defined in claim 1 wherein the dynamic reference phase shifting is locked to an independently measured sample motion signal or any signal proportional to this signal such as a pressure or a vibrational signal.

9. Use of the apparatus as defined in claim 1 wherein the dynamic reference phase shifting is synchronized with a heart beating cycle.
